(19) United States
(12) Patent Application Publication
(10) Pub. No.: US 2010/0063899 A1
(43) Pub. Date: Mar. 11, 2010

(54) SYSTEM AND METHOD FOR ELECTRONIC COMMERCE USING PORTABLE MEMORY

(76) Inventor: Joon-Wan Kim, Incheon (KR)

Correspondence Address: SHERR & VAUGHN, PLLC, 620 HERNDON PARKWAY, SUITE 320, HERNDON, VA, 20170, US

(21) Appl. No.: 12/513,267

(22) PCT Filed: Oct. 23, 2007
(86) PCT No.: PCT/KR07/05209

§ 371 Date: May 1, 2009

(30) Foreign Application Priority Data
Nov. 3, 2006 (KR) 10-2006-0108324

(51) Int. Cl. G06Q 30/00; G06Q 20/00; G06F 12/00

(52) U.S. Cl. 705/27; 711/115; 711/E12.001

(57) ABSTRACT

The present invention relates to an electronic commerce system and method using portable memory. The electronic commerce system using portable memory includes a shopping mall provision module for providing an online shopping mall to a communication terminal connected through the Internet, a code reception module for receiving the unique identification code of the portable memory, connected to the communication terminal, through the communication terminal, and a payment processing module for performing processing so that a specific amount of money corresponding to a price of a product, purchase of which is requested, is subtracted from a specific amount of money, assigned to the received unique identification code and stored in a DB, upon a request from the communication terminal for the purchase of the product.

### TECHNICAL FIELD

The present invention relates, in general, to an electronic commerce system and method using portable memory and, more particularly, to an electronic commerce system and method using portable memory, in which a corporation provides the members or customers thereof with portable memory that can be connected to communication terminals to enable users to purchase various products from an Internet shopping mall, rather than providing members or customers with merchandise coupons, souvenirs or thank-you gifts in a uniform way, thereby widening the options of the members or the customers with respect to products.

### BACKGROUND ART

Generally, companies purchase specific products at discount prices in large quantities, and provide them to employees for the purpose of promoting loyalty to the companies or to good customers for the purpose of advertising the companies on festive days, such as Thanksgiving Day or New Year's Day. This scheme has an advantage of purchasing products at discount prices, but has a problem in that products do not have variety due to the purchase of the products in large quantities, so that this scheme cannot satisfy employees' or customers' various demands. In particular, it is difficult to obtain an expected advertising effect using products that are lacking in variety, which are provided to customers, because interest in products lacking in variety wanes over time, even though the logos or advertising slogans of the companies are printed on the products so as to advertise the companies. Accordingly, some companies provide merchandise coupons available for shopping at specific large-sized marts or specific Internet shopping malls so as to realize the simplification of purchasing procedures and various options on products.

However, the scheme of allowing persons to purchase products at Internet shopping malls using merchandise coupons generally has a problem in that users suffer great inconvenience of use because users typically must go through a membership subscription procedure requiring agreement on terms of use, and they must search for and assess corresponding websites, go through a login procedure and then purchase products.

### DISCLOSURE

### Technical Problem

Accordingly, the present invention has been made keeping in mind the above problems occurring in the prior art, and an object of the present invention is to provide an electronic commerce system and method using portable memory, which enables users to conveniently purchase various products from an Internet shopping mall using the portable memory, which stores a unique identification code for enabling the purchase of products from the Internet shopping mall and an access program for providing automatic access to the Internet shopping mall using the unique identification code.

### Technical Solution

In order to accomplish the above object, the present invention provides an electronic commerce system using portable memory comprising a shopping mall provision module for providing an online shopping mall to a communication terminal connected through the Internet, a code reception module for receiving the unique identification code of the portable memory, connected to the communication terminal, through the communication terminal, and a payment processing module for performing processing so that a specific amount of money corresponding to a price of a product, purchase of which is requested, is subtracted from a specific amount of money, assigned to the received unique identification code and stored in a DB, upon a request from the communication terminal for the purchase of the product.

### ADVANTAGEOUS EFFECTS

According to the above-described electronic commerce system and method using portable memory, there are advantages in that a company that provides thank-you gifts, souvenirs or the like can satisfy employees' or customers' various demands, can reduce the working load of a person in charge of purchasing products, and can advertise the company using the portable memory, on which an advertising slogan is printed, for a long time.

Furthermore, purchasers who are given the portable memory of the present invention are provided with advantages in that they can purchase various products, can selectively purchase required products without temporal limitation, and can conveniently and safely engage in electronic commerce because the running of web browsers, access to a shopping mall, and electronic payment, which must be secure, are automatically carried out merely by connecting the portable memory to a terminal.

### DESCRIPTION OF DRAWINGS

FIG. 1 is a block diagram illustrating the general flow of electronic commerce in an electronic commerce system according to the present invention;

FIG. 2 is a flowchart illustrating a method in which a seller inputs information about a product, purchased from a manufacturer, to the electronic commerce system of the present invention;

FIG. 3 is a flowchart illustrating a method in which a seller provides the portable memory of the present invention to a corporate purchaser;

FIG. 4 is a front view showing the appearance of portable memory according to an embodiment of the present invention;

FIG. 5 is a flowchart showing a method in which a corporate purchaser distributes the portable memory of the present invention, supplied by a seller, to employees;

FIG. 6 is a flowchart illustrating a method in which a manufacturer delivers a product to an employee of a corporate purchaser, who uses the electronic commerce system of the present invention;

FIG. 7 is a block diagram illustrating an embodiment of data that is input to the sales server of the present invention;

FIG. 8 is a block diagram illustrating an embodiment of data that is output from the sales server of the present invention;

FIG. 9 is a network configuration diagram of an electronic commerce system using portable memory according to an embodiment of the present invention;

FIG. 10 is an electric block diagram of portable memory according to an embodiment of the present invention; and

FIGS. 11 to 13 are flowcharts showing an electronic commerce method using portable memory according to an embodiment of the present invention.

*** Description of reference numerals
of principle elements in the drawings ***

| | |
|---|---|
| 100: portable memory | 110: interface unit |
| 120: control logic | 130: memory |
| 200: purchasing terminal | 300: Internet |
| 400: sales server | 410: authentication processing module |
| 420: shopping mall provision | 430: delivery processing module |
| module | |
| 440: charging processing module | 500: DB |
| 510: product DB | 520: unique identification code DB |
| 530: remaining money DB | 540: delivery location DB |
| 600: delivery server | 700: payment server |

### MODE FOR INVENTION

It is preferred that the above-described construction further include a charging processing module for performing processing in conjunction with the payment server so that charging for the amount of money assigned to the received unique identification code and stored in the DB can be performed upon a request from the communication terminal for charging for money; a transfer processing module for performing processing so that part of the amount of money, assigned to the received unique identification code, can be assigned to another unique identification code upon a request from the communication terminal for the transfer of money; and an authentication processing module for authenticating access of the communication terminal by checking the received unique identification code.

Furthermore, an electronic commerce method using portable memory according to another embodiment of the present invention includes step (a) of providing an online shopping mall to a communication terminal; step (b) of receiving a unique identification code for the purchase of a product from portable memory, connected to the communication terminal, through the communication terminal; and step (c) of performing processing so that the price of a product, the purchase of which is requested by the communication terminal, can be subtracted from the amount of money assigned to the unique identification code received at step (b).

It is preferred that the above construction further include step (d) of performing processing so that charging for the amount of money assigned to the unique identification code received at step (b) is performed; step (e) of performing processing so that the amount of money assigned to a unique identification code is assigned to another unique identification code; step (f) of receiving delivery location information from the communication terminal, storing the delivery location information, performing delivery based on the received delivery location information, and utilizing the stored delivery location information at the time of subsequent delivery; or step (g) of authenticating the login of the communication terminal by checking the unique identification code received at step (b).

With reference to the accompanying drawings, an electronic commerce system and method using portable memory according to a preferred embodiment of the present invention will be described in detail below.

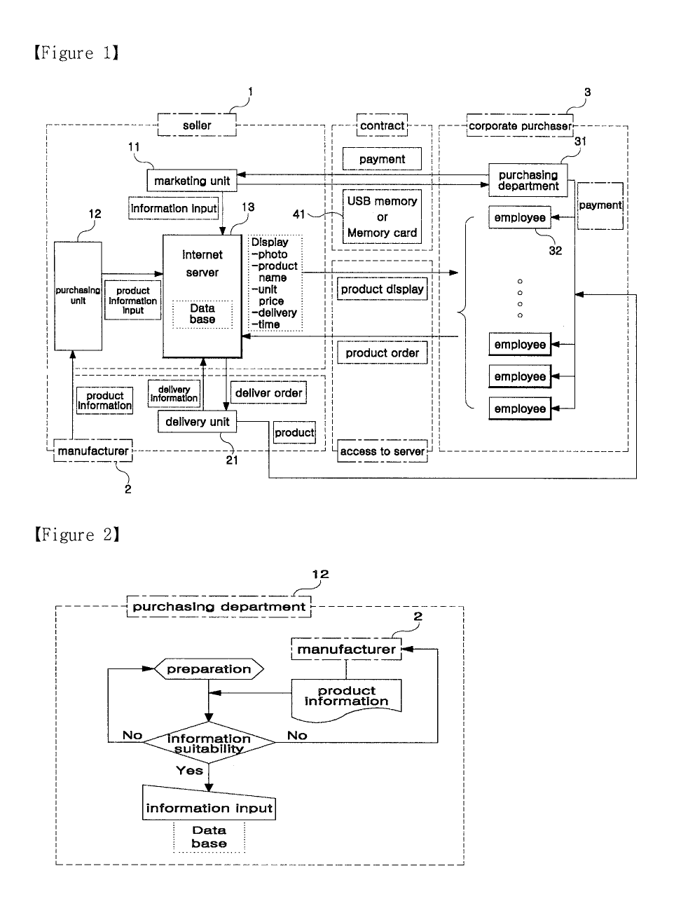

FIG. 1 is a block diagram illustrating the general flow of electronic commerce in the electronic commerce system according to the present invention.

As illustrated in FIG. 1, a corporate purchaser 3 that provides thank-you gifts and souvenirs to employees and customers enters into a contact with a seller 1 who has constructed an Internet shopping mall that is provided with various types of products. Under this contact, the corporate purchaser 3 provides money to the seller 1, and the seller 1 provides portable memory 41, on which a company advertisement slogan is printed and in which a unique identification code is embedded, to the corporate purchaser 3. Here, it is preferred that the portable memory 41 be stick-type USB memory or a memory card. The portable memory 41 may be used for purposes other than an electronic commerce purpose.

Furthermore, the marketing department 11 of the seller 1 determines the number of users (employees or customers) that can use the sales server 13, the amount of money available for the purchase of products for each user and an advertising slogan to be printed on the portable memory 41 under the contact with the purchasing department 31 of the corporate purchaser 3.

Meanwhile, the corporate purchaser 3 provides the portable memory 41, supplied by the seller 1, to employees 31 or customers in place of thank-you gifts or souvenirs. Accordingly, the employees 31 install the provided portable memory 41 in purchasing terminals (not shown), such as personal computers or mobile communication terminals, access the sales server 13, constructed by the seller 1, through the purchasing terminals, purchase desired products through the purchasing terminals based on product information received from the sales server 13, and receive the purchased products.

FIG. 2 is a flowchart illustrating a method in which a seller inputs information about a product, purchased from a manufacturer, to the electronic commerce system of the present invention.

As illustrated in FIG. 2, the purchasing department 12 of the seller 1 receives various types of product information from the manufacturer 2 in the form of an electronic document that is created such that it is compatible with the sales server 13 constructed for electronic commerce, and inputs the product information to the sales server 13. In this case, the manufacturer 2 notifies the purchasing department 12 of the name, characteristics, size, or weight of a product, the supply date for the product, or the quantity of the product to be supplied. And the purchasing department 12 determines whether the relevant product meets characteristics required by the present invention, that is, the characteristics of a thank-you gift or souvenir based on the provided data. Inputs data, particularly data necessary for electronic commerce with the corporate purchaser 3, to the product server 13 if, as the result of the determination, the relevant product is found to meet the characteristics. And notifies the manufacturer 2 that the product does not meet the characteristics if, as the result of the determination, the relevant product is found not to meet the characteristics.

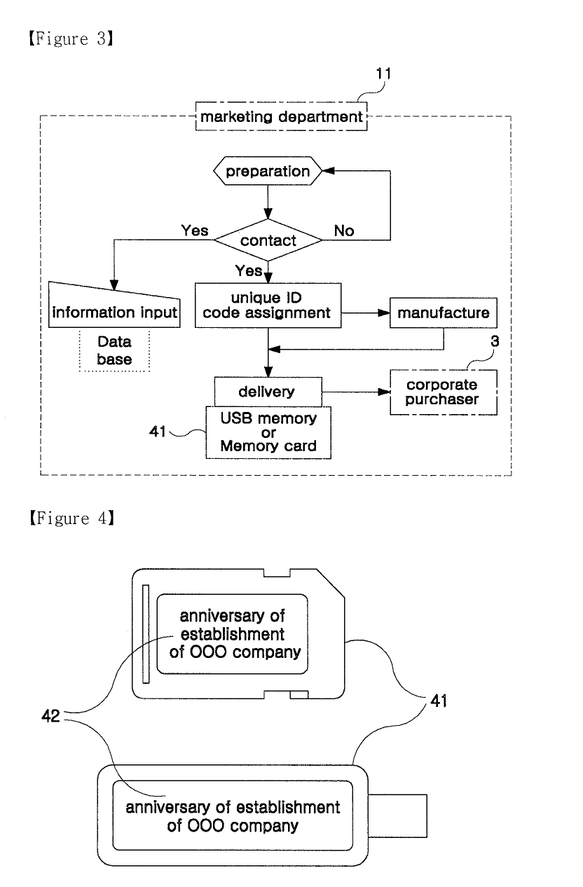

FIG. 3 is a flowchart illustrating a method in which a seller provides the portable memory of the present invention to a corporate purchaser. FIG. 4 is a front view showing the appearance of portable memory according to an embodiment of the present invention.

As illustrated in FIG. 3, when a contract is established between the seller 1 and the corporate purchaser 3, the corporate purchaser 3 pays money to the seller 1. Accordingly, the seller 1 performs a manufacturing process of inputting a unique identification code and an automatic access program to the portable memory 41 and printing an advertising slogan 42, requested by the corporate purchaser 11 as shown in FIG. 4, on the portable memory 41. Furthermore, the seller 1 inputs information about the amount of money available for each unique identification code to be input to the portable memory 41, to the sales server 13, and sends the portable memory 41 to the corporate purchaser 3 after the input has been completed.

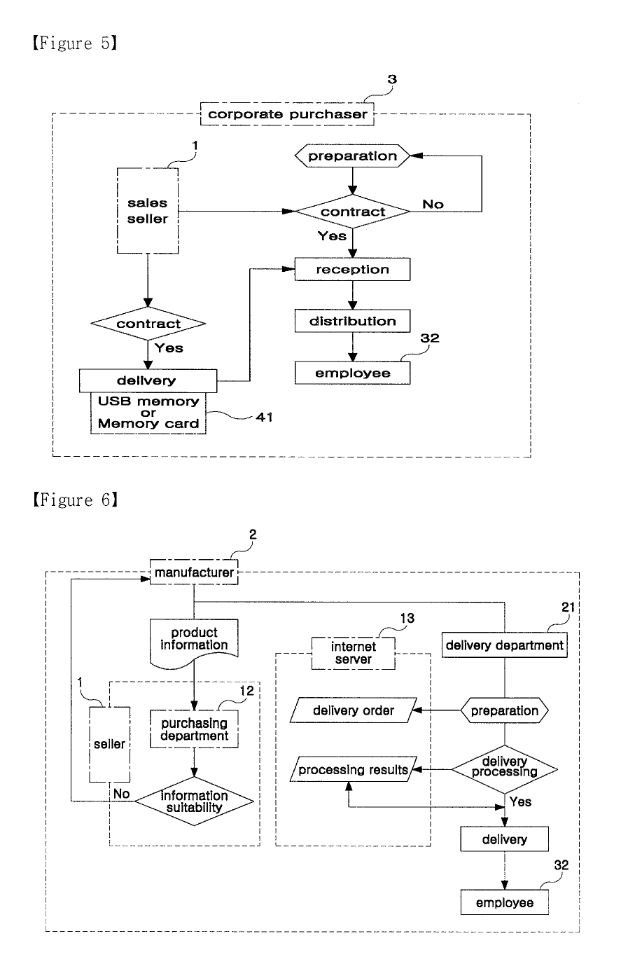

FIG. 5 is a flowchart illustrating a method in which the corporate purchaser distributes the portable memory of the present invention, supplied by the seller, to the employees. As shown in this drawing, the corporate purchaser 3 distributes the portable memory 41, received from the seller 1, to the employees 32 or the customers.

FIG. 6 is a flowchart illustrating a method in which the manufacturer delivers a product to an employee of the corporate purchaser, who uses the electronic commerce system of the present invention. When an employee 32, who belongs to the corporate purchaser 3, purchases a product through the sales server 13, the seller 1 issues a delivery order to the delivery department 21 of the manufacturer 2. Accordingly, the delivery department 21, which received the order, processes delivery, and inputs the results of the delivery to the sales server 13, so that the employee 32 can check the delivery information.

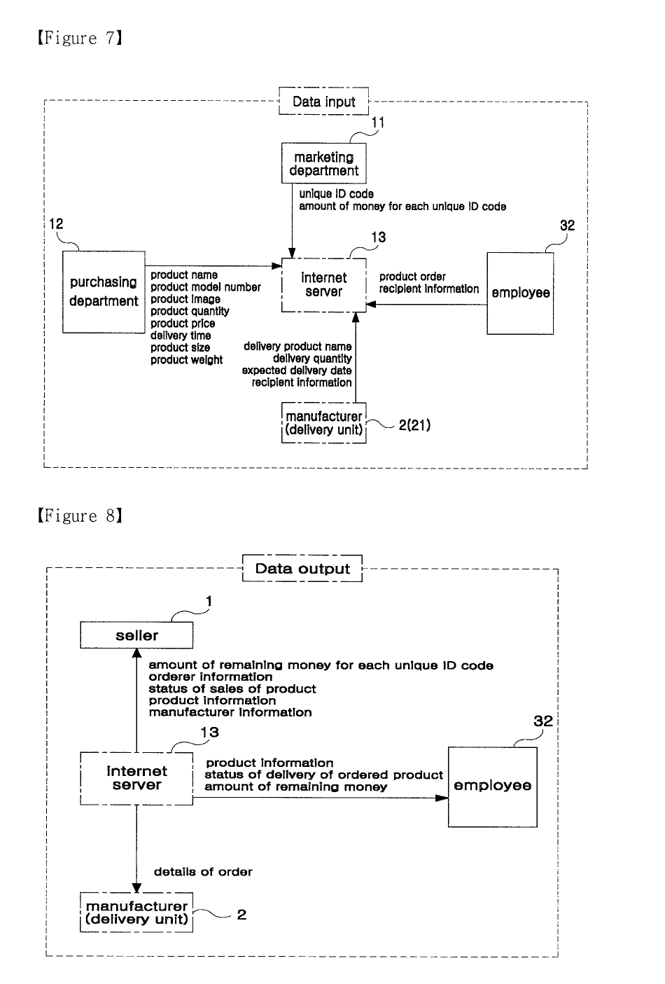

FIG. 7 is a block diagram illustrating an embodiment of data that is input to the sales server of the present invention, and FIG. 8 is a block diagram illustrating an embodiment of data that is output from the sales server of the present invention.

That is, with regard to data input to the sales server 13, the marketing department 11 inputs a unique identification code and the amount of money for each unique identification code, the purchasing department 12 inputs product information, the delivery department 21 inputs information about a delivered product and information about the delivery of a product, and the employee 32 inputs an order for a product and recipient information. Furthermore, with regard to data output from the sales server 13, information about a unique identification code, orderer information, the amount of money remaining, sales status, product information and manufacturer information are output to the seller 1, product information, delivery information and information about the amount of money remaining are output to the employee 32, and order information is output to the manufacturer 2.

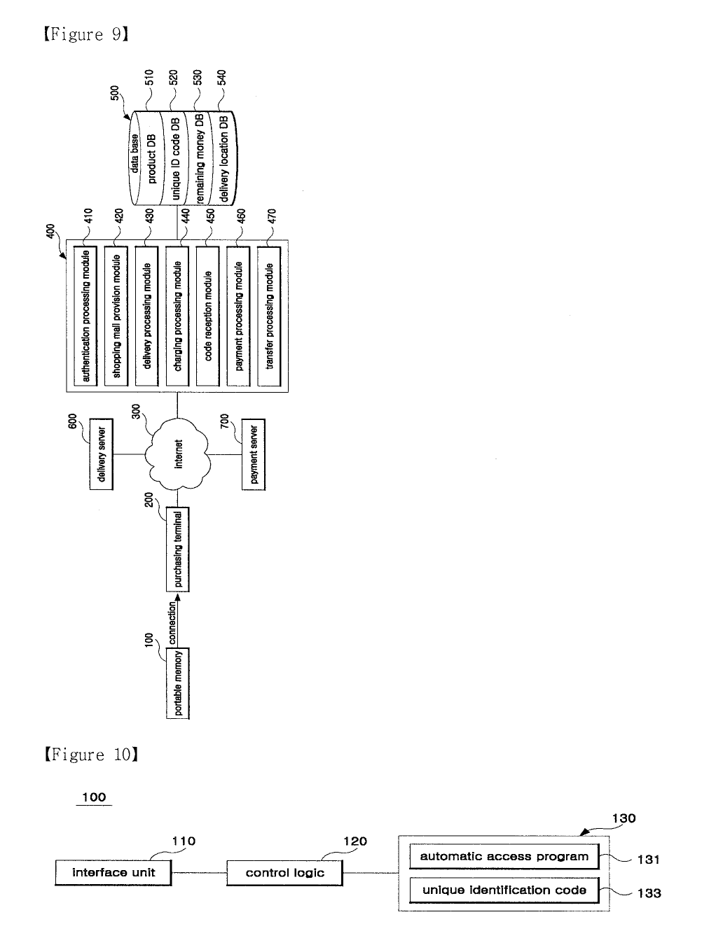

FIG. 9 is a network configuration diagram of an electronic commerce system using portable memory according to an embodiment of the present invention, and FIG. 10 is an electric block diagram of portable memory according to an embodiment of the present invention.

As shown in FIG. 9, the electronic commerce system according to the present invention includes a purchasing terminal 200 configured to allow portable memory 100 to be connected thereto, a sales server 400 for providing an Internet shopping mall, a DB 500 for storing various types of information related to the operation of the shopping mall, a delivery server 600, a payment server 700, and the Internet 300 for connecting the above components to each other.

As shown in FIG. 10, the portable memory 100 includes an interface unit 110 connected to the purchasing terminal 200; memory 130 for storing the unique identification code 133 of the portable memory 100 for enabling products to be purchased in the sales server 400 and an automatic access program 131 for enabling automatic access to the sales server 400 through the purchasing terminal 200; and a control logic 120 for controlling the above components.

The sales server 400 includes a code reception module 450 for receiving the unique identification code of the portable memory 100 through the communication terminal 200; an authentication processing module 410 for authenticating the access of the purchasing terminal 200 by checking the unique identification code received from the purchasing terminal 200; a shopping mall provision module 420 for providing an online shopping mall to the purchasing terminal 200 that makes access through the Internet 300; a payment processing module 460 for performing processing so that a specific amount of money corresponding to the price of products, the purchase of which is requested, is subtracted from the amount of money stored in the DB 500 corresponding to the unique identification code received through the code reception module 450, upon the request from the communication terminal 200 for the purchase of the products; a delivery processing module 430 for enabling delivery to be processed by sending delivery location information for the purchased product to the delivery server 600; a charging processing module 440 for performing processing in conjunction with the payment server 700 so that charging for the amount of money assigned to the unique identification code received through the code reception module 450 and stored in the DB 500 can be performed upon the request from the communication terminal 200 for charging for the money; and a transfer processing module 470 for performing processing so that part of the money, assigned to the unique identification code received through the code reception module 450, can be assigned to another unique identification code upon the request from the communication terminal 200 for transfer.

The DB 500 includes a unique identification code DB 520 for storing the unique identification code, which is a basis for the authentication of the authentication processing module 410 and is stored in the portable memory 100; a product DB 510 for storing information about purchasable products, such as the names, characteristics or discount prices of the products for each unique identification code stored in the unique identification code DB 520; a remaining money DB 530 for storing the amount of remaining money, which can be used to purchase products, for each unique identification code stored in the unique identification code DB 520; and a delivery location DB 540 for storing delivery location information for each unique identification code stored in the unique identification code DB 520.

Meanwhile, in the above-description construction of FIG. 9, the portable memory 100 is operated using power from the purchasing terminal 200. Accordingly, the control logic 120 sends the ‘unique identification code’ and an ‘access signal’ for enabling access to the sales server 400 using the unique identification code to the purchasing terminal 200 based on the automatic access program.

The purchasing terminal 200 is implemented using a computer or a mobile communication terminal that is equipped with an access terminal for performing connection to the portable memory 100, particularly a USB terminal, and communication means for performing communication with the sales server 400 via the Internet 300, and logs in to the sales server 400 based on the unique identification code and the access signal input from the connected portable memory 100.

The concept of the Internet 300 includes a network configuration that is connected to a mobile communication terminal that ensures wireless communication and mobility. The Internet 300 includes the wireless Internet, which enables access to the Internet through a mobile communication network based on a platform, such as Wireless Application Protocol (WAP) or WIPI, which has been introduced already or will be introduced, or that enables access to the Internet through a public wireless LAN or an Access Point (AP); and the ‘portable Internet (WiBro or WiMax),’ which is wireless Internet service that enables high-speed Internet access at rest or in slow motion at ADSL-level quality and cost.

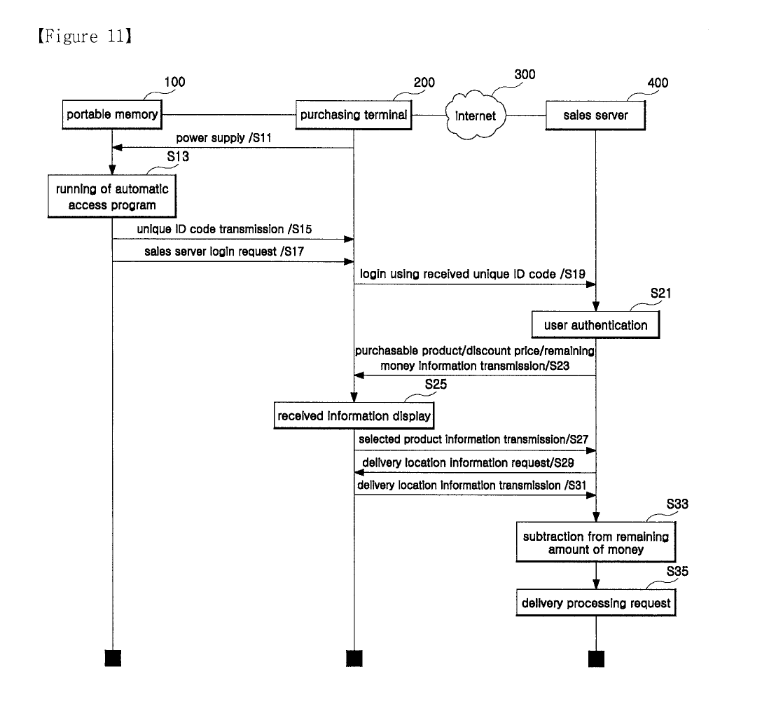

FIGS. 11 to 13 are flowcharts showing an electronic commerce method using portable memory according to an embodiment of the present invention.

First, at step S11, the purchasing terminal 200 supplies power to the connected portable memory 100. Accordingly, the portable memory 100 runs the automatic access program at step S13, proceeds to step S15 and then sends a unique identification code to the purchasing terminal 200, and requests that the purchasing terminal 200 log in to the sales server 400 at step S17. Thereafter, at step S19, the purchasing terminal 200 makes a login request to the sales server 400 using the unique identification code input from the portable memory 100.

Thereafter, the sales server 400 authenticates the access of the purchasing terminal 200 by determining whether the unique identification code received at step S21 is a unique identification code stored in the unique identification code DB 520, and proceeds to step S23 and then sends information about the names and discount prices of products and the amount of remaining money, available to the received unique identification code, to the purchasing terminal 200.

Thereafter, the purchasing terminal 200 display the information from the sales server 400 at step S25, and sends information about the product selected by the purchaser to the sales server 400 at step S27. Meanwhile, the sales server 400 requests delivery location information from the purchasing terminal 200 at step S29 if the delivery location information of the purchaser, who sends the information about a product at step S27, that is, who requests the purchase of a product, is not stored in the delivery location DB 540, and thus the purchasing terminal 200 sends the delivery location information, input by the purchaser at step S31, to the sales server 400. In contrast, if the delivery location information of the purchaser, who requests the purchase of a product, is stored in the delivery location DB 540, it is preferred that steps S29 and step S31 be omitted.

Thereafter, the sales server 400 subtracts the price of the product, purchased by the purchaser, from the amount of remaining money stored in the remaining money DB 530 at step S33, proceeds to step S35 and then sends information about the selected product and the delivery location information to the delivery server 600, and requests that the delivery server 600 process delivery so that the product can be delivered to the purchaser.

In a typical electronic commerce system, the running of a web browser, access to a shopping mall and electronic payment, which must be secure, are all performed through the manipulation of a terminal by a purchaser, while, in the above-described process, these operations are automatically processed by connecting the portable memory 100 to the purchasing terminal 200, thereby being convenient.

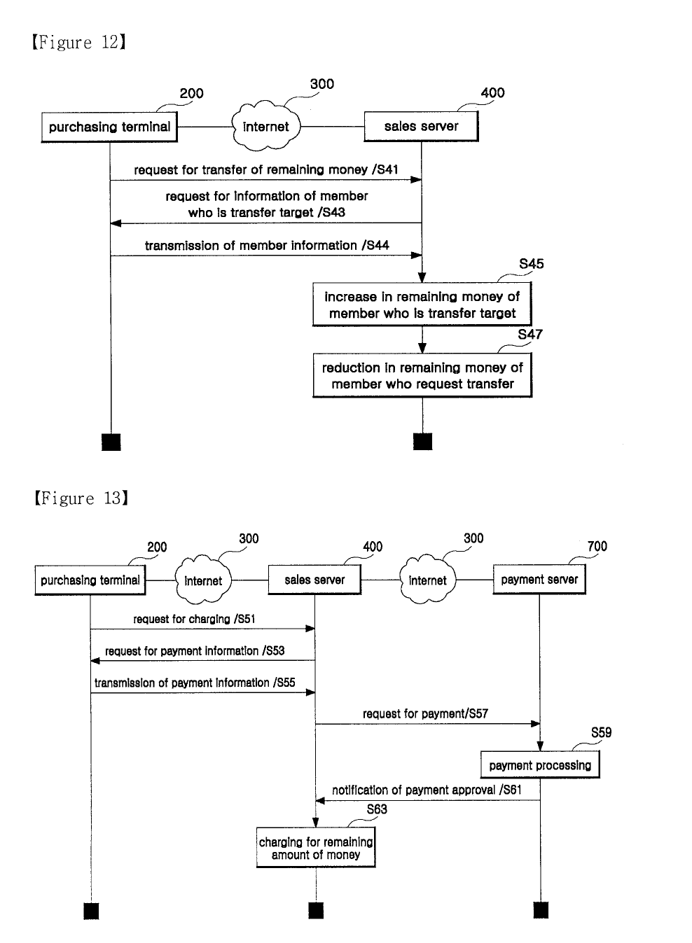

Meanwhile, FIG. 12 shows a process of making gifts of money, that is, the amounts of remaining money stored in the remaining money DB 530, between purchasers who have the portable memory 100 according to the present invention. As a result, an effect of freely and safely making gifts through the portable memory 100 on-line is expected.

First, the purchasing terminal 200 requests the transfer of the remaining money from the sales server 400 at step S41, the sales server 400 requests information about a member, that is, a transfer target, such as a unique identification code, at step S43, and the purchasing terminal 200 returns member information to the sales server 400 at step S44.

Thereafter, the sales server 400 checks the member information received at step S44 and then increases the amount of remaining money of the transfer target member by the amount requested by the purchaser at step S45, and decreases the amount of money of the member who requests the transfer in accordance with step S45, at step S47.

Thereafter, FIG. 13 shows a process of performing charging for the amount of remaining money stored in the remaining money DB 530. Through this process, an effect in which purchasers can safely, conveniently and continually use portable memory 100 that is provided in the form of thank-you gifts is expected.

First, the purchasing terminal 200 requests charging from the sales server 400 at step S51, the sales server 400 requests payment information at step S53, and the purchasing terminal 200 returns payment information at step S55.

Thereafter, when the sales server 400 requests payment by sending the payment information, received from the purchasing terminal 200, to the payment server 700 at step S57, the payment server 700 makes a payment based on the received payment information at step S59, and proceeds to step S61 and then notifies the sales server 400 of approval for the payment. Accordingly, the sales server 400 performs charging for a specific amount of money, requested by the purchaser, based on the provided approval information at step S63.

The electronic commerce system and method using portable memory according to the present invention are not limited to the above-described embodiments, but may be variously modified and worked within the scope of the technical spirit of the present invention.

1-2. (canceled)

3. An electronic commerce system using portable memory, comprising:
the portable memory comprising:
an interface unit connected to a purchasing terminal,
memory for storing a unique identification code of the portable memory and an automatic access program for enabling automatic access to a sales server through the purchasing terminal, and
control logic for controlling the portable memory; and
a sales server comprising:
a shopping mall provision module for providing an online shopping mall to a communication terminal connected through the Internet,
a code reception module, connected to the communication terminal, for receiving the unique identification code of the portable memory through the communication terminal,
an authentication processing module for authenticating access of the communication terminal by checking the received unique identification code,
a payment processing module for performing processing so that a specific amount of money corresponding to a price of a product, purchase of which is requested, is subtracted from a specific amount of money, assigned to the received unique identification code and stored in a database, upon a request from the communication terminal for the purchase of the product, and
a transfer processing module for performing processing so that part of the amount of money, assigned to the received unique identification code, can be assigned to another unique identification code upon a request from the communication terminal for transfer of money.

4. The electronic commerce system according to claim 3, further comprising a charging processing module for performing processing in conjunction with the payment server so that charging for the amount of money assigned to the received unique identification code and stored in the database can be performed upon a request from the communication terminal for charging for money.
